(19) United States
(12) Patent Application Publication
(10) Pub. No.: US 2019/0053586 A1
(43) Pub. Date: Feb. 21, 2019

(54) REMOVABLY ATTACHABLE JEWELRY ORNAMENT FOR A BRACELET SUBSTRATE

(71) Applicant: J Bandz LLC, Rockville, MD (US)

(72) Inventors: Marc POTASH, Rockville, MD (US); Jack Potash, Rockville, MD (US); Jordan Potash, Rockvillle, MD (US)

(21) Appl. No.: 15/678,887

(22) Filed: Aug. 16, 2017

(51) Int. Cl. A44C 25/00; A44C 5/00; A44C 15/00; A44C 9/00; A41D 27/08; A43B 23/24; G06K 19/07

(52) U.S. Cl. CPC A44C 25/007; A44C 5/0015; A44C 5/0053; A44C 15/005; G06K 19/0723; A44C 9/00; A41D 27/08; A43B 23/24; A44C 15/0085

(57) ABSTRACT

A jewelry ornament removably attachable to a bracelet substrate is provided. The jewelry ornament including a first member having an upper surface and a lower surface, a second member having an upper surface and a lower surface, and an articulation structure. The articulation structure may be configured to allow the jewelry ornament to be removably coupled to the bracelet substrate. The lower surface of the first member may include a first portion configured to contact an upper surface of the bracelet substrate. The upper surface of the second member may include a first portion configured to contact a lower surface of the bracelet substrate. The entire lower surface of the first member may be a flat surface arranged in a single plane. The entire upper surface of the second member may be a flat surface arranged in a single plane.

### BACKGROUND

A charm bracelet is a piece of jewelry that includes one or more decorative ornaments (e.g., charms) coupled to a jewelry substrate (e.g., chain, wire, band, etc.). Each charm bracelet may be unique because a wearer may customize the bracelet by selecting decorative ornaments that have significance to the wearer. For example, a decorative ornament may have sentimental value, represent a special occasion, serve as a memento or souvenir, allow the wearer to express individual style or preferences, signify an affiliation with an organization, a group, an institution, etc.

In order to create the charm bracelet, the decorative ornaments may be coupled to the jewelry substrate in a permanent or removable fashion. When the decorative ornaments are coupled to the jewelry substrate in a permanent fashion, the wearer is unable to customize the bracelet to reflect a current individual style. Instead, the wearer is restricted to the set configuration of the charm bracelet because it is difficult to add or remove decorative ornaments without additional tools or coupling means (e.g., jewelry pliers, jump rings, solder, etc.).

When a charm bracelet is created using removable decorative ornaments, the wearer may easily customize the charm bracelet and interchange the decorative ornaments. However, due to the removable nature of how the decorative ornaments are attached to the jewelry substrate, the likelihood that a decorative ornament will inadvertently become detached, and potentially lost, while the charm bracelet is being worn is significantly increased.

In order to reduce the likelihood that a decorative ornament is lost from a charm bracelet while allowing decorative ornament customization, jewelry designers have created charm bracelets that use a jewelry substrate having a fastener where the decorative ornaments are arranged on the jewelry substrate when the charm bracelet is not secured to the wearer. For example, the decorative ornaments are designed to be threaded onto the jewelry substrate when the fastener is unlatched. The decorative ornaments are arranged on the jewelry substrate by threading the decorative ornament onto the jewelry substrate and sliding each decorative ornament along the length of the jewelry substrate. After the decorative ornaments are arranged on the jewelry substrate and the fastener is re-latched, the likelihood that the decorative ornaments will disconnect from the jewelry substrate is reduced. However, the ease of reconfiguring the arrangement of the decorative ornaments after the decorative ornaments are threaded on the jewelry substrate is reduced because in order to rearrange, add, and/or remove a decorative ornament from the jewelry substrate, the one or more of the decorative ornaments need to be slideably removed from the jewelry substrate and then re-threaded onto the jewelry substrate in a configuration that reflects the current individual style of the wearer.

### SUMMARY

Various embodiments include a jewelry ornament removably attachable to a bracelet substrate. The jewelry ornament may include a first member having an upper surface and a lower surface; a second member having an upper surface and a lower surface; and an articulation structure coupled with the first member and the second member, the articulation structure configured to allow the jewelry ornament to be removably coupled to the bracelet substrate. The lower surface of the first member may include a first portion configured to contact an upper surface of the bracelet substrate and a second portion configured to contact the upper surface of the second member. The upper surface of the second member may include a first portion configured to contact a lower surface of the bracelet substrate and a second portion configured to contact the lower surface of the first member. The entire lower surface of the first member may be a flat surface arranged in a single plane. The entire upper surface of the second member may be a flat surface arranged in a single plane.

In some embodiments, the articulation structure may be a hinge such as a floating hinge or a spring hinge.

In various embodiment, the first member may include a core formed of a rigid material, and a covering formed of a flexible material in contact with at least a portion of the core of the first member. The second member may include a core formed of a rigid material, and a covering formed of a flexible material in contact with at least a portion of the core of the second member. The lower surface of the first member may comprise the covering of the first member, and the upper surface of the second member may comprise the covering of the second member. The articulation structure may be coupled with the core of the first member and the core of the second member. The covering of the second member may contact a greater portion of the core of the second member than the covering of the first member contacts the core of the first member. The lower surface of the first member and the upper surface of the second member may deform when in contact with the bracelet substrate.

In some embodiments, the jewelry ornament may further include a coupling element configured to removably couple the first member and the second member. The first member of the jewelry ornament may include an article arranged on the upper surface of the first member. The article may be at least one of an alphanumeric character, insignia, emblem, logo, icon, image, symbol, and an object. The article may be a timepiece arranged on the upper surface of the first member.

In various embodiments, the jewelry ornament may be fixedly attached to the bracelet substrate when the lower surface of the first member contacts the upper surface of the bracelet substrate and the upper surface of the second member contacts the lower surface of the bracelet substrate such that jewelry ornament is not readily movable with respect to the bracelet substrate. The bracelet substrate may be a continuous band of flexible material.

In some embodiments, at least one of a length of the lower surface of the first member and a length of the upper surface of the second member is greater than a width of the bracelet substrate.

Various embodiments may also include a bracelet comprising a bracelet substrate; and a jewelry ornament removably coupled to the bracelet substrate. The jewelry ornament may include a first member having an upper surface and a lower surface, a second member having an upper surface and a lower surface, and an articulation structure coupled with the first member and the second member, the articulation structure configured to allow the jewelry ornament to be removably coupled to the bracelet substrate. The lower surface of the first member may include a first portion configured to contact an upper surface of the bracelet substrate and a second portion configured to contact the upper surface of the second member. The upper surface of the second member may include a first portion configured to contact a lower surface of the bracelet substrate and a second portion configured to contact the lower surface of the first member. The entire lower surface of the first member may be a flat surface arranged in a single plane. The entire upper surface of the second member may be a flat surface arranged in a single plane. The jewelry ornament may be fixedly attached to the bracelet substrate when the lower surface of the first member contacts the upper surface of the bracelet substrate and the upper surface of the second member contacts the lower surface of the bracelet substrate such that jewelry ornament is not readily movable with respect to the bracelet substrate.

In some embodiments, the bracelet substrate may be a continuous band of a flexible material. The flexible material may be a woven material.

In various embodiments, the bracelet may further include a radio-frequency identification (RFID) element. The RFID element may be included in at least one of the first member of the jewelry ornament, the second member of the jewelry ornament, and the bracelet substrate.

Various embodiments may also include an ornament removably attachable to a wearable substrate. The ornament may include a first member having an upper surface and a lower surface; a second member having an upper surface and a lower surface; and an articulation structure coupled to the first member and the second member, the articulation structure configured to allow the ornament to be removably coupled to the wearable substrate. The lower surface of the first member may include a portion configured to contact a first surface of the wearable substrate. The upper surface of the second member may include a portion configured to contact a second surface of the wearable substrate. The entire lower surface of the first member may be a flat surface arranged in a single plane, and the entire upper surface of the second member may be a flat surface arranged in a single plane.

In some embodiments, the wearable substrate may include at least one of a circlet, a necklace, a bracelet, a ring, an anklet, a shoe lace, and clothing fabric.

### BRIEF DESCRIPTION OF THE DRAWINGS

The accompanying drawings, which are incorporated herein and constitute part of this specification, illustrate exemplary embodiments, and together with the general description given above and the detailed description given below, serve to explain the features of the claims.

FIG. 1 illustrates a perspective view of a removably attachable jewelry ornament according to various embodiments.

FIGS. 2 and 3 illustrate side views of the removably attachable jewelry ornament illustrated in FIG. 1.

FIGS. 4 and 5 illustrate side views of a removably attachable jewelry ornament according to various embodiments.

FIGS. 6 and 7 illustrate top views of removably attachable jewelry ornaments according to various embodiments.

FIG. 8 illustrates a perspective view of a bracelet including a removably attachable jewelry ornament according to various embodiments.

FIG. 9 illustrates a side view of a removably attachable jewelry ornament according to various embodiments.

FIG. 10 illustrates a side view of a removably attachable jewelry ornament according to various embodiments.

FIG. 11 illustrates a side view of a removably attachable jewelry ornament according to various embodiments.

FIG. 12 illustrates a perspective view of a removably attachable jewelry ornament according to various embodiments.

FIG. 13 illustrates a perspective view of a removably attachable jewelry ornament according to various embodiments.

FIG. 14 illustrates a side view of the removably attachable jewelry ornament illustrated in FIG. 13.

FIG. 15 illustrates a perspective view of a removably attachable jewelry ornament according to various embodiments.

FIG. 16 illustrates a side view of the removably attachable jewelry ornament illustrated in FIG. 15.

FIG. 17 illustrates a side view of a removably attachable jewelry ornament according to various embodiments.

FIGS. 18A and 18B illustrate side views of the removably attachable jewelry ornament illustrated in FIG. 12 according to various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

The following description with reference to the accompanying figures is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used to enable a clear and consistent understanding of the present disclosure. Accordingly, it should be apparent to those skilled in the art that the following description of various embodiments of the present disclosure is provided for illustration purposes only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The terms “have”, “may have”, “can have,” “include”, “may include”, “can include”, “comprise”, and the like used herein indicate the existence of a corresponding feature (e.g., a number, a function, an operation, or an element) and do not exclude the existence of an additional feature.

The terms “A or B”, “at least one of A and/or B”, or “one or more of A and/or B” may include all possible combinations of items listed together. For example, the terms “A or B”, “at least one of A and B”, or “at least one of A or B” may indicate all the cases of (1) including at least one A, (2) including at least one B, and (3) including at least one A and at least one B.

The terms “first”, “second”, and the like used herein may modify various elements regardless of the order and/or priority thereof, and are used only for distinguishing one element from another element, without limiting the elements. For example, “a first element” and “a second element” may indicate different elements regardless of the order or priority. For example, without departing the scope of the present disclosure, a first element may be referred to as a second element and vice versa.

A decorative jewelry ornament, such as a bauble, a trinket, an amulet, or a charm, may be worn for various reasons. For example, a decorative jewelry ornament may be worn for enjoyment or aesthetic purposes, have sentimental value or significance, reflect an individual style or preference, signify an affiliation with a group, organization, institution, etc., serve as a memento or souvenir, communicate a message or health information, etc. In order to reduce a number of pieces of jewelry needed to communicate a unique individual style, it is beneficial for a decorative jewelry ornament to be removably attachable to a jewelry substrate. The ability to removably attach or interchange decorative jewelry ornaments on a jewelry substrate allows a wearer to quickly and easily customize a piece of jewelry unique to the wearer.

Most interchangeable decorative ornaments use complex fastening mechanisms requiring highly dexterous skills to securely couple an ornament to a jewelry substrate. For example, removably attachable decorative ornaments are typically coupled to a jewelry substrate that includes a fastener or clasp where the fastener must be unlatched in order to slide or thread the decorative ornament onto the substrate. Because a child may have reduced fine motor skills, the size of the fasteners and the dexterity needed to attach decorative ornaments to a jewelry substrate may be too complex for a child to perform unassisted. Therefore, it is beneficial for a decorative jewelry ornament to be configured such that either an adult or a child could removably attach a decorative jewelry ornament to a jewelry substrate. In addition, it is beneficial to implement such a decorative jewelry ornament with a jewelry substrate that does not include clasps or fasteners such as a continuous loop or band substrate.

Moreover, a child may have a high activity level which may introduce a greater likelihood that a decorative ornament may unintentionally disconnect from the jewelry substrate and be lost. A decorative jewelry ornament that is composed of materials that minimize monetary loss while being configured to minimize unintentionally disconnection from the jewelry substrate as well as allow the child to independently create and customize a charm bracelet may reduce the chance of unintentional disconnection and loss.

Various embodiments provide decorative jewelry ornaments that are removably attachable to a jewelry substrate. In some embodiments, a jewelry ornament may include a first member, a second member, and an articulation structure coupled with the first member and the second member to allow the jewelry ornament to be removably coupled to a bracelet substrate. In some embodiments, a lower surface of the first member may include a first portion configured to contact an upper surface of the bracelet substrate and a second portion configured to contact the upper surface of the second member. In some embodiments, the upper surface of the second member may include a first portion configured to contact a lower surface of the bracelet substrate and a second portion configured to contact the lower surface of the first member. In some embodiments, the entire lower surface of the first member may be a flat surface arranged in a single plane and the entire upper surface of the second member may be a flat surface arranged in a single plane.

In various embodiments, the jewelry ornament may be fixedly attached to the bracelet substrate when the lower surface of the first member contacts the upper surface of the bracelet substrate and the upper surface of the second member contacts the lower surface of the bracelet substrate such that the jewelry ornament is not readily movable with respect to the bracelet substrate. In some embodiments, a decorative ornament may be removably coupled to a jewelry substrate such as a necklace substrate, a bracelet substrate, or an anklet substrate. Alternatively, a decorative ornament may be removably coupled to a wearable substrate such as a shoe lace or clothing fabric.

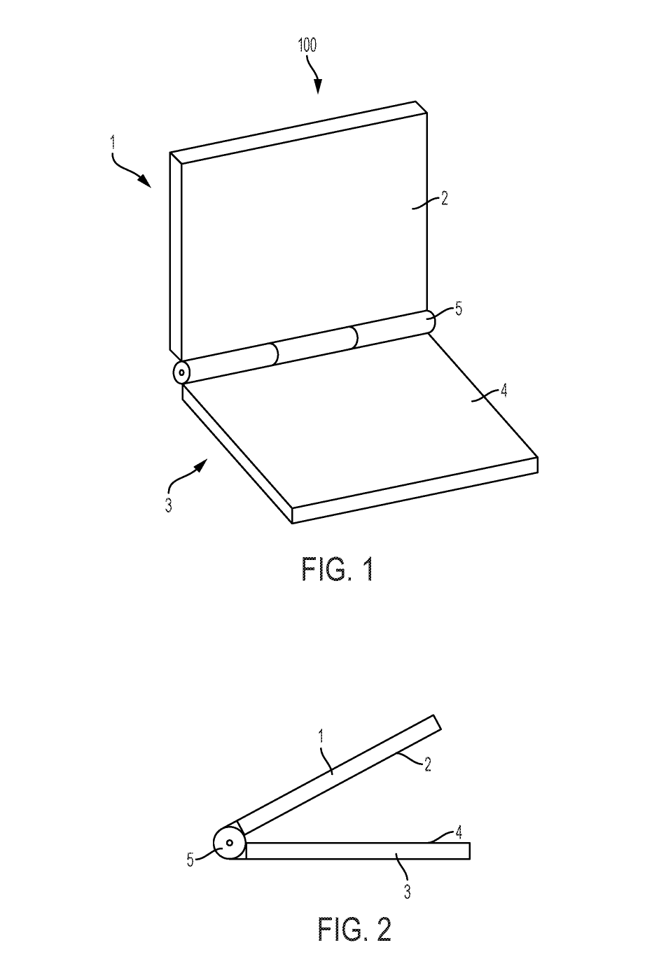

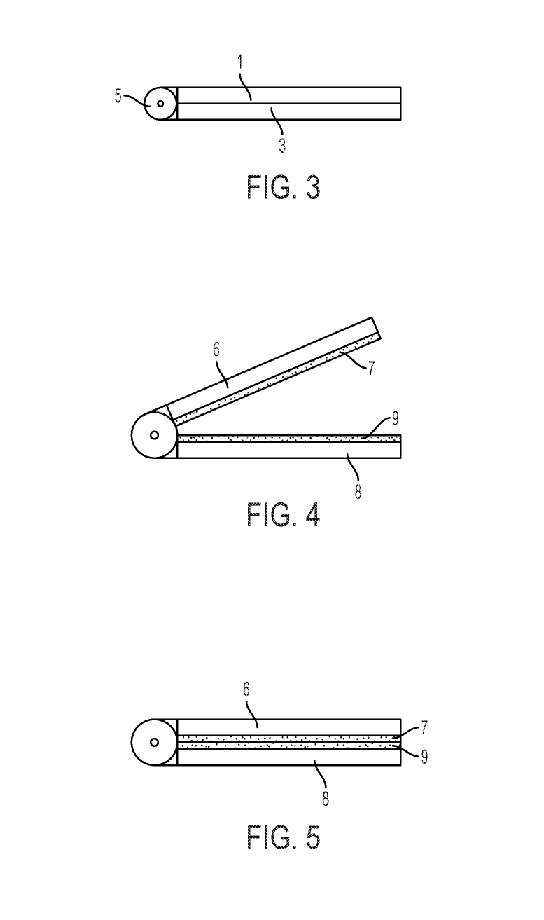

FIGS. 1-3 illustrate an exemplary removably attachable jewelry ornament 100 according to various embodiments. FIG. 1 illustrates a perspective view of the removably attachable jewelry ornament 100. FIG. 2 illustrates a side view of the removably attachable jewelry ornament 100 where the ornament 100 is arranged in an open position. FIG. 3 illustrates a side view of the removably attachable jewelry ornament 100 where the ornament 100 is arranged in a closed position.

Referring to FIGS. 1-3, the removably attachable jewelry ornament 100 may include a first member 1, a second member 3, and an articulation structure 5 coupled with the first member 1 and the second member 3. It is noted that while the removably attachable jewelry ornament 100 is illustrated in FIGS. 1-3 as having a substantially rectangular shape, the ornament 100 may have any shape including, but not limited to, a geometric shape such as round, square, oval, etc. and/or a shape representing an object such as a character, a tree, a flower, a clock, etc.

In addition, the size and/or the shape of the first member 1 and the second member 3 of the removably attachable jewelry ornament 100 may be the same or different. For example, as illustrated in FIGS. 1-3, the first member 1 may have a shape and size that is the same as the shape and size of the second member 3. Alternatively, the first member 1 may have a shape that is different from the second member 3. For example, the first member 1 may have a square shape and the second member 3 may have a round shape or vice versa. Also, the first member 1 may be smaller than the second member 3 where portions of the second member 3 are visible when the first member 1 is coupled to the second member 3. Alternatively, the second member 3 may have a shape that is smaller than the first member 1 where portions of the first member 1 extend beyond the edges of the second member 3 when the first member 1 is coupled to the second member 3.

The first member 1 may include an upper surface and a lower surface 2 where the entire lower surface 2 of the first member 1 is a flat surface arranged in a single plane. The second member 3 may include an upper surface 4 and a lower surface where the entire upper surface 4 of the second member 3 is a flat surface arranged in a single plane. In some embodiments, the lower surface 2 may be arranged in a plane different from, yet substantially parallel to, the plane in which the upper surface 4 of the second member 3 is arranged.

In some embodiments, the first member 1 and the second member 3 are made of rigid material. For example, the first member 1 and/or the second member 3 may be made of plastic, metal, stone, glass, etc. or any combination thereof or of other materials. In some embodiments, the first member 1 and the second member 3 may be made of the same material. Alternatively, the first member 1 and the second member 3 may be made of different materials.

The articulation structure 5 may be coupled with the first member 1 and the second member 3. The articulation structure 5 may be configured to allow the removably attachable jewelry ornament 100 to be removably coupled to a jewelry substrate. In some embodiments, the articulation structure 5 may be a hinge such as a floating hinge and/or a spring hinge.

The articulation structure may be coupled to the first member 1 and the second member 3. In some embodiments, the articulation structure 5 may be coupled to an outer periphery surface of the first member 1 and an outer periphery surface of the second member 3 of the removably attachable jewelry ornament 100. In some embodiments, the articulation structure 5 may be a separate element from the first member 1 and/or the second member 3 where the articulation structure 5 is formed separately and then coupled to the outer periphery surface of the first member 1 and the outer periphery surface of the second member 3 by affixing the articulation structure 5 to the first member 1 and the second member 3. In some embodiments, a portion of the articulation structure 5 may be integrally formed with the first member 1 and a portion of the articulation structure 5 may be integrally formed with the second member 3.

In some embodiments, the articulation structure 5 may include a hole for accommodating a hinge pin. The hinge pin may be inserted into the hole in the articulation structure 5 in order to connect the first member 1 and the second member 3. The removably attachable jewelry ornament 100 may rotate or pivot with respect to an axis associated with the hinge pin in order to open and close the removably attachable jewelry ornament 100. When the articulation structure 5 is a spring hinge, the articulation structure 5 may include a separate structure or spring to apply pressure on the first member 1 and the second member 3 which creates a force to secure the removably attachable jewelry ornament 100 in the closed position. Alternatively, portions of the hinge pin (e.g., the ends) may be formed to apply the spring loaded forces to secure the removably attachable jewelry ornament 100 in the closed position.

FIGS. 4 and 5 illustrate side views of another removably attachable jewelry ornament according to various embodiments. FIG. 4 illustrates a side view of a removably attachable jewelry ornament where the ornament is arranged in an open position. FIG. 5 illustrates a side view of the removably attachable jewelry ornament where the ornament is arranged in a closed position.

Referring to FIGS. 4 and 5, the first member 1 of the removably attachable jewelry ornament 100 may include a first core 6 and a first covering substrate 7 and the second member 3 of the removably attachable jewelry ornament 100 may include a second core 8 and a second covering substrate 9. In some embodiments, the lower surface 2 of the first member 1 may include the first covering substrate 7 and the upper surface 4 of the second member 3 may include the second covering substrate 9. In some embodiments, the lower surface 2 of the first member 1 may include the first core 6 and the upper surface 4 of the second member 3 may include the second core 8 such that the first covering substrate 7 and the second covering substrate 9 are coupled to the lower surface 2 of the first member 1 and the upper surface 4 of the second member 2, respectively. In some embodiments, the articulation structure 5 may be coupled to the first core 6 and the second core 8.

The first core 6 and/or the second core 8 may be formed of a rigid material. For example, the rigid material may be plastic, metal, stone, glass, etc. or any combination thereof or any other material. In some embodiments, the first core 6 may be formed of the same material as the second core 8. Alternatively, the first core 6 may be formed of different material from the second core 8. In some embodiments, the thickness of the first core 6 may be the same or different from the thickness (or height) of the second core 8. For example, the first core 6 may have a thickness greater than the second core 8. Alternatively, the second core 8 may have a thickness greater than the first core 6.

The first covering substrate 7 may be in contact with at least a portion of the first core 6. For example, the first covering substrate 7 may be in contact with a lower surface of the first core 6. While illustrated in FIGS. 4 and 5 as being in contact with the entire lower surface of the first core 6, the first covering substrate 7 may be smaller than the entire surface of the first core 6 such that at least a portion of the lower surface of the first core 6 is exposed beyond the edges of the first covering substrate 7. In some embodiments, the first covering substrate 7 may be coupled to the first core 6 using any coupling technique including printing, gluing, lamination, etching, sputtering, etc.

The second covering substrate 9 may be in contact with at least a portion of the second core 8. For example, the second covering substrate 9 may be in contact with an upper surface of the second core 8. While illustrated in FIGS. 4 and 5 as being in contact with the entire upper surface of the second core 8, the second covering substrate 9 may be smaller than the entire surface of the second core 8 such that at least a portion of the upper surface of the second core 8 is exposed beyond the edges of the second covering substrate 9. In some embodiments, the second covering substrate 9 may be coupled to the second core 8 using any coupling technique including printing, gluing, lamination, etching, sputtering, etc.

The size of the first covering substrate 7 may be the same or different from the size of the second covering substrate 9. For example, the first covering substrate 7 may have a size greater than the second covering substrate 9 such that a greater portion of the upper surface of the second core 8 is exposed than the portion of the lower surface that is exposed of the first core 6. Alternatively, the second covering substrate 9 may have a size greater than the first covering substrate 7 such that a greater portion of the lower surface of the first core 6 is exposed than the portion of the upper surface that is exposed of the second core 8. Additionally or alternatively, the thickness (or height) of the first covering substrate 7 may be the same or different from the thickness of the second covering substrate 9. For example, the first covering substrate 7 may have a thickness that is greater than a thickness of the second covering substrate 9. Alternatively, the second covering substrate 9 may have a thickness that is greater than a thickness of the first covering substrate 7.

In some embodiments, the first covering substrate 7 and/or the second covering substrate 9 may formed of a flexible material. For example, the first covering substrate 7 and/or the second covering substrate 9 may be formed of silicone, fabric, felt, hook and loop material, etc. or any combination thereof or any other material. In some embodiments, the first covering substrate 7 may be formed of the same material as the second covering substrate 9. Alternatively, the first covering substrate 7 may be formed of a different material from the second covering substrate 9.

In some embodiments, the first covering substrate 7 and/or the second covering substrate 9 may be configured to deform. For example, when the first member 1 and the third member 3 are in an open position (e.g., not in contact with each other), the entire lower surface of the first covering substrate 7 may be a flat surface arranged in a single plane and/or the entire upper surface of the second covering substrate 9 may be a flat surface arranged in a single plane where the first covering substrate 7 and the second covering substrate 9 maintain an original thickness. When the first member 1 and the second member 3 are in a closed position without being removably coupled to a jewelry substrate, the entire lower surface of the first covering substrate 7 and/or the entire upper surface of the second covering substrate 9 may come in contact with each other which may cause a minor deformation that results in a minor change in thickness of the first covering substrate 7 and/or the second covering substrate 9. In some embodiments, when the first member 1 and the second member 3 are in a closed position without being removably coupled to a jewelry substrate, a lower surface of the first covering substrate 7 may be substantially parallel to the lower surface of the first core 6 such that the entire lower surface of the first covering substrate 7 is a flat surface arranged in a single plane. Likewise, an upper surface of the second covering substrate 9 may be substantially parallel to the upper surface of the second core 8 such that the entire upper surface of the second covering substrate 9 is a flat surface arranged in a single plane.

In some embodiments, the first covering substrate 7 and the second covering substrate 9 may be formed of materials having different deformation properties. For example, the first covering substrate 7 may be formed of a material that results in greater deformation when a pressure is applied such that the first covering substrate 7 is configured to deform more than the second covering substrate 9 when the same pressure is applied to both the first covering substrate 7 and the second covering substrate 9. Alternatively, the second covering substrate 9 may be formed of a material that results in greater deformation when a pressure is applied such that the second covering substrate 9 is configured to deform more than the first covering substrate 7 when the same pressure is applied to both the first covering substrate 7 and the second covering substrate 9.

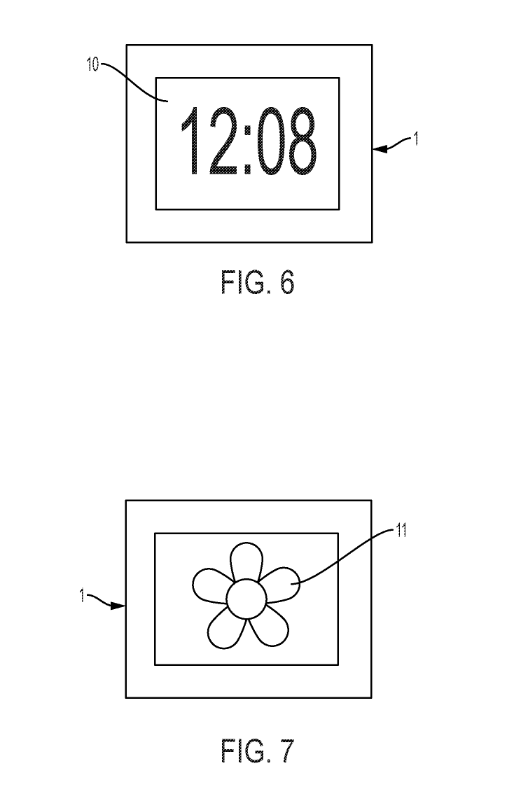

FIGS. 6 and 7 illustrate top views of exemplary removably attachable jewelry ornaments according to various embodiments. In various embodiments, a jewelry ornament may include an article that performs or provides an informational and/or decorative function. FIG. 6 illustrates a top view of a removably attachable jewelry ornament including, as an example, a watch or timepiece. FIG. 7 illustrates a top view of a removably attachable jewelry ornament including, as an example, a depiction of a flower.

In some embodiments, the removably attachable jewelry ornament 100 may include an article arranged on an upper surface of the first member 1. The article may be any two-dimensional and/or three-dimensional object, visual indicator, writing, or printing. In some embodiments, the object, visual indicator, writing, or printing may indicate, signal, express, or relate to a communication, expression, or style. In some embodiments, the communication, expression, or style may correspond to a wearer of the removably attachable jewelry ornament 100 and/or to one that selected the removably attachable jewelry ornament 100. In some embodiments, the article may include one or more of an alphanumeric character, an insignia, an emblem, a logo, an icon, an image, a symbol, an object, etc.

Referring to FIG. 6, the article may include a digital timepiece 10 where the digital timepiece 10 is arranged on the upper surface of the first member 1. Referring to FIG. 7, the article may include an icon of a flower 11 where the flower is arranged on the upper surface of the first member 1.

In some embodiments, the article may be smaller than the size of the upper surface of the first member 1. For example, as illustrated in FIGS. 6 and 7, the digital timepiece 10 and the flower 11 are smaller than the entire upper surface of the first member 1 such that at least a portion of the upper surface is exposed and visible. Alternatively, the article may have a size substantially equal to or greater than the upper surface of the first member 1. For example, when the article has a size greater than the upper surface of the first member 1, portions of the article may extend beyond the edges of the upper surface of the first member 1.

In some embodiments, the article may be formed separate from the first member 1 and then attached to the first member 1 using any coupling or attaching means. Alternatively or additionally, at least a portion of the article may be integrally formed with the first member 1. The article may be printed or etched into the upper surface of the first member 1. In some embodiments, the article may be a sticker or a hologram. In some embodiments, the article may include a device such as the digital watch 10, an analog watch, a projector, a display, a camera, a speaker, a microphone, a transceiver, a processor, a battery, etc. In some embodiments, the article may depict a mascot, such as of a team, school, organization, or association. In some embodiments, the article may depict a character from, e.g., a book (including comic books), television, movie, game (including video game), etc. For example, the article may include a depiction of a Pokémon® character. Other examples are also possible.

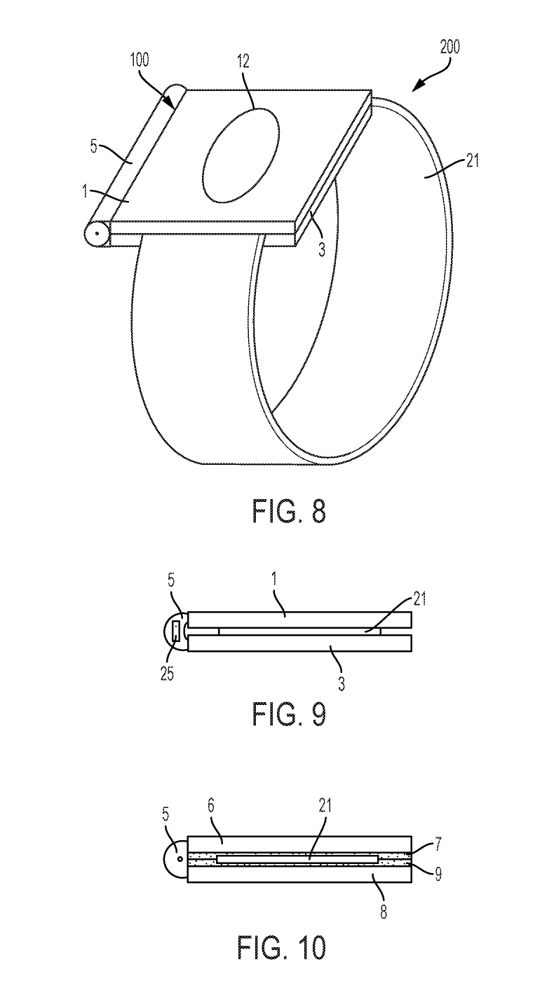

FIG. 8 illustrates a perspective view of a bracelet including a removably attachable jewelry ornament 100 according to various embodiments. While the removably attachable jewelry ornament 100 is illustrated in FIG. 8 as being removably attached to the bracelet substrate 21, the removably attachable jewelry ornament 100 may be removably attached to any jewelry substrate, any wearable substrate, or any substrate that allows the jewelry ornament 100 to be removably attached. For example, a jewelry substrate may include one or more of a circlet, a necklace, a bracelet, a ring, an anklet, a chain, a rope, etc. In some embodiments, the jewelry substrate may include one or more of a bead, a stone, a pearl, a fastener, a link, etc. In some embodiments, a wearable substrate may include one or more of a shoe lace, clothing fabric, a ribbon, etc. In some embodiments, a substrate that allows the jewelry ornament 100 to be removably attached may include one or more of a woven fabric, a sheet of material such as paper, cardboard, wood, metal, silicone, etc.

Referring to FIG. 8, the bracelet 200 may include the removably attachable jewelry ornament 100 and a bracelet substrate 21. While only one removably attachable jewelry ornament 100 is illustrated in FIG. 8 as being coupled to the bracelet substrate 21, any number of removably attachable jewelry ornaments 100 may be coupled to the bracelet substrate 21 at the same time.

The removably attachable jewelry ornament 100 may be attached to the bracelet substrate 21 in a removable manner such that the articulation structure 5 allows the first member 1 and the second member 3 to rotate to open and then close to surround a portion of the bracelet substrate 21. In some embodiments, the removably attachable jewelry ornament 100 may include an article 12 and be fixedly attached to the bracelet substrate 21 when the lower surface 2 of the first member 1 contacts the upper surface of the bracelet substrate 21 and the upper surface of the second member 3 contacts the lower surface of the bracelet substrate. This may allow the removably attachable jewelry ornament 100 to be secured to the bracelet substrate 21 such that the removably attachable jewelry ornament 100 is not readily movable with respect to the bracelet substrate 21.

In some embodiments, when the removably attachable jewelry ornament 100 is coupled to the bracelet substrate 21, the articulation structure 5 of the removably attachable jewelry ornament 100 is arranged longitudinally with respect to the bracelet substrate 21 and the first member 1 and the second member 3 extend from the articulation structure 5 inches in a lengthwise direction with respect to the width of the bracelet substrate 21. As illustrated in FIG. 8, the removably attachable jewelry ornament 100 may have a length greater than a width of the bracelet substrate 21. For example, at least one of a length of the lower surface 2 of the first member 1 and a length of the upper surface 4 of the second member 3 is greater than a width of the bracelet substrate 21 such that at least a portion of the lower surface 2 and the upper surface 4 extend beyond the width of the bracelet substrate 21. Alternatively, the length of the first member 1 and the second member 3 may be less than the width of the bracelet substrate 21 such that the bracelet substrate 21 extends beyond the edges of the first member 1 and the second member 3.

While the articulation structure 5 is illustrated in FIG. 8 as being arranged on the left side of the bracelet substrate 21, the articulation structure 5 may alternatively be arranged on the right side of the bracelet substrate 21.

As illustrated in FIG. 8, the lower surface 2 of the first member 1 may include a first portion configured to contact an upper surface of the bracelet substrate 21 and a second portion configured to contact the upper surface 4 of the second member 2. In addition, the upper surface of the second member 3 may include a first portion configured to contact a lower surface of the bracelet substrate 21 and a second portion configured to contact the lower surface 2 of the first member.

The bracelet substrate 21 may include a continuous band of material. In some embodiments, the flexible material of the continuous band may be a woven material. In some embodiments, the continuous band of material may be flexible such that the continuous band of material is capable of being deformed in one or more directions. For example, the continuous band of material may be flexible to stretch around a hand and then conform to a wrist. This flexibility may allow the bracelet 200 to be easily put on and taken off while also securing the bracelet 200 to a wearer. In addition, the continuous band of material may have a predetermined thickness yet also be flexible such that the portion of the bracelet substrate 21 that is in contact with the removably attachable jewelry ornament 100 is deformed when the removably attachable jewelry ornament 100 is fastened to the bracelet substrate 21. This may prevent the removably attachable jewelry ornament 100 from sliding or becoming displaced with respect to the bracelet substrate 21. In some embodiments, the upper surface of the bracelet substrate and the lower surface of the bracelet substrate are substantially planar. In some embodiments, the upper surface of the bracelet substrate and the lower surface of the bracelet substrate may be substantially parallel to each other.

FIG. 9 illustrates a side view of the removably attachable jewelry ornament 100 according to various embodiments. Referring to FIG. 9, the articulation structure 5 of the removably attachable jewelry ornament 100 may include a floating hinge 25. In some embodiments, the articulation structure 5 may be coupled to the first member 1 and the second member 3 such that the floating hinge 25 allows the first member 1 and the second member 3 to rotate about two different axes of rotation. For example, the first member 1 and the second member 3 are separately coupled to the floating hinge 25 such that the first member 1 and the second member 3 rotate about a first axis associated with the articulation structure 5. In addition, the first member 1 and the second member 3 may be moved to rotate about a second axis such that the first member 1 may move relative to the second member 3. This allows the first member 1 and the second member 3 to be arranged substantially parallel to each other when the removably attachable jewelry ornament 100 is coupled to the bracelet substrate 21.

FIG. 10 illustrates a side view of the removably attachable jewelry ornament 100 according to various embodiments. Referring to FIG. 10, the first member 1 may include the first core 6 and the first covering substrate 7 and the second member 7 may include the second core 8 and the second covering substrate 90.

In some embodiments, the lower surface of the first covering substrate 7 of the first member 1 and/or the upper surface of the second covering substrate 9 of the second member 3 may deform when in contact with the bracelet substrate 21. For example, the first covering substrate 7 and/or the second covering substrate 9 may be made of a flexible material such that the first covering substrate 7 and/or the second covering substrate 9 deform with respect to the bracelet substrate 21 when the removably attachable jewelry ornament 100 is coupled to the bracelet substrate 21.

In another embodiment, a first surface of the first covering substrate 7 and/or a first surface of the second covering substrate 9 may be different from a second surface of the first covering substrate 7 and/or a second surface of the second covering substrate 9. For example, the first covering substrate 7 of the first member 1 and/or the upper surface of the second covering substrate 9 of the second member 3 may include a notch formed in the lower surface of the first covering substrate 7 and/or the upper surface of the second covering substrate 9, respectively.

For example, as illustrated in FIG. 10, the first core 6 may have a lower surface that is a flat surface arranged in a single plane and the second core 8 may have an upper surface that is a flat surface arranged in a single plane different from the plane of the lower surface of the first core 6. A first covering substrate 7 may be coupled to the lower surface of the first core 6 and the lower surface of the first covering substrate 7 may be formed such that a first portion of the lower surface of the first covering substrate 7 is arranged in a first plane and a second portion of the lower surface of the first covering substrate 7 is arranged in a second plane different from the first plane. In some embodiments, the first portion of the lower surface of the first covering substrate 7 may be arranged above or below the second portion of the lower surface of the first covering substrate 7. Likewise, a second covering substrate 9 may be coupled to the upper surface of the second core 8 and the upper surface of the second covering substrate 9 may be formed such that first portion of the upper surface of the second covering substrate 9 is arranged in a third plane and a second portion of the upper surface of the second covering substrate 9 is arranged in a fourth plane different from the third plane. In some embodiments, the first portion of the upper surface of the second covering substrate 9 may be arranged above or below the second portion of the upper surface of the second covering substrate 9.

In some embodiments, when the first portion of the first covering substrate 7 is arranged above the plane associated with the second portion of the first covering substrate 7 and the first portion of the second covering substrate 9 is arranged above the plane associated with the second portion of the second covering substrate 9, the first portion of the first covering substrate 7 may be in contact with the first portion of the upper surface of the second covering substrate 9 when the removably attachable jewelry ornament 100 is coupled to the bracelet substrate 21. In addition, the bracelet substrate 21 may be arranged within the notch formed by the second portions of the first covering substrate 7 and the second covering substrate 9 when the removably attachable jewelry ornament 100 is coupled to the bracelet substrate 21.

While the notch is illustrated FIG. 10 as being in both the first covering substrate 7 and the second covering substrate 9, the notch may be arranged in only one of the first covering substrate 7 or the second covering substrate 9. In addition, while the edges of the notch are shown in FIG. 10 as being right angles, the edges of the notch may have any shape or configuration including being rounded, step-wise notches, etc.

In some embodiments, the first portion and/or the second portion of the first covering substrate 7 and/or the first portion and/or the second portion of the second covering substrate 9 may further include one or more additional projections. For example, the one or more additional projections arranged within the notch or a surface configured to contact the mirroring surface may increase frictional force and prevent the removably attachable jewelry ornament 100 from sliding with respect to the bracelet substrate and/or unintentionally or prematurely disengaging from the bracelet substrate. For example, the first portion and/or the second portion of the first covering substrate 7 and/or the first portion and/or the second portion of the second covering substrate 9 may include one or more ridges or projections that protrude from or one or more troughs or channels that recede from a surface of one of the portions of the lower surface of the first covering substrate 7 and/or the upper surface of the second covering substrate 9. The ridges, projections, troughs, or channels may have any shape, size or configuration. In addition, the ridges, projections, troughs, or channels may introduce a surface of the first covering substrate 7 and/or the second covering substrate 9 that is arranged in a third plane. In some embodiments, the third plane may be the same as one of the first or second planes or the third plane may be different from the first and/or second planes of the first and second portions of the respective covering substrates 7, 9. In various embodiments, a third material may be associated with one or more of the ridges, projections, troughs, or channels such that the third material may be the same or different from the material of the respective cores 6, 8 and/or the covering substrates 7, 9.

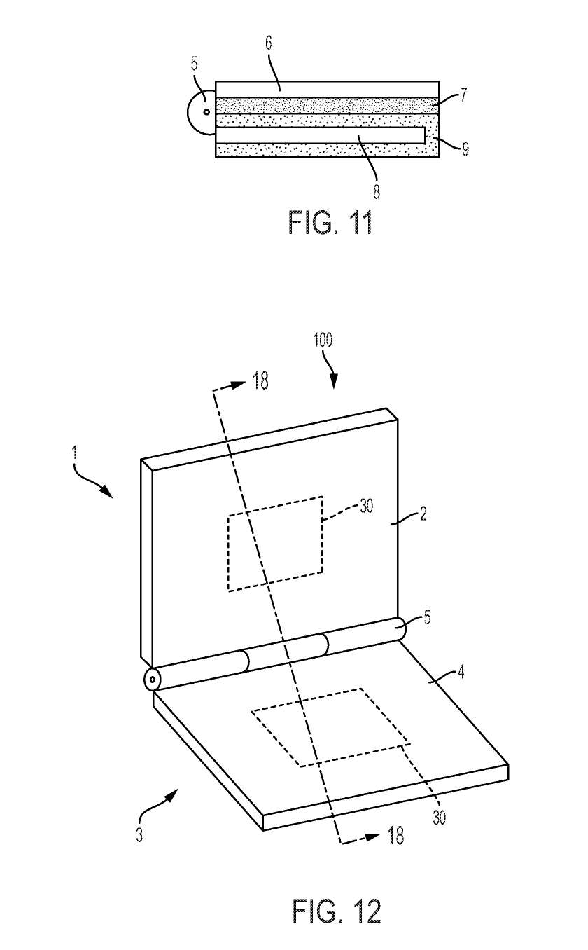

FIG. 11 illustrates a side view of the removably attachable jewelry ornament 100 according to various embodiments. In some embodiments, the first covering substrate 7 may have a different surface area than the second covering substrate 9. For example, the first covering substrate 7 may having a greater surface area than the second covering substrate 9. Alternatively, the second covering substrate 9 may have a greater surface area than the first covering substrate 7.

In some embodiments, the second covering substrate 9 may contact a greater portion of the second core 8 than the first covering substrate 7 contacts the first core 6. For example, as illustrated in FIG. 11, the first covering substrate 7 may be coupled to the lower surface of the first core 6 and the second covering substrate 9 may be coupled to the upper surface of the second core 8, a side edge of the second core 8, and a lower surface of the second core 8. While the second covering substrate 9 is illustrated in FIG. 11 as being in contact with three surfaces of the second core 8, the second covering substrate 9 may have a greater surface area than the first covering substrate 7 while not being in contact with three surfaces of the second core 8 such that the second covering substrate 9 is arranged on any or all portions of the surfaces of the second core 8. For example, the second covering substrate 9 may be two separate substrates where a first substrate is in contact with the upper surface of the second core 8 and a second substrate is in contact with the lower surface of the second core 8. In some embodiments, when the second covering substrate 9 is coupled to the lower surface of the second core 8, the second covering substrate 9 may provide comfort to a wearer by reducing undesired friction when the removably attachable jewelry ornament 100 is coupled with a jewelry substrate.

FIGS. 12-17, 18A and 18B illustrate exemplary removably attachable jewelry ornaments 100 including a coupling element according to various embodiments. In some embodiments, the removably attachable jewelry ornament 100 may include a coupling element configured to removably couple the first member 1 and the second member 3. For example, the coupling element may include one or more of a magnet, a clip, a post, and a latch.

Referring to FIGS. 12, 18A, and 18B, the removably attachable jewelry ornament 100 may include one or more magnets 30 such that the one or more magnets 30 are configured to allow the removably attachable jewelry ornament 100 to be coupled to a jewelry substrate. For example, one or more magnets 30 may allow the first member 1 and the second member 3 to be coupled together through the jewelry substrate (e.g., bracelet substrate 21).

Axis 18 illustrated in FIG. 12 is the cutaway axis of the removably attachable jewelry ornament 100 where FIGS. 18A and 18B illustrate the removably attachable jewelry ornament 100 along axis 18. As illustrated in FIG. 18A, the magnets 30 include two magnets where the magnets 30 are coupled to the first member 1 and the second member 3 such that the upper and lower surface of the magnets 30 are substantially flush with the upper surface and the lower surface 2 of the first member 1 and the upper surface 4 and the lower surface of the second member 3. In some embodiments, an article may be further coupled to the first member 3 via the magnet 30 coupled to the first member 1. While the magnets 30 are illustrated as being substantially flush with both the upper and lower surfaces of both the first member 1 and the second member 3, the magnets 30 may be substantially flush with the lower surface 2 of the first member 1 and/or the upper surface 4 of the second member 3. Alternatively, as illustrated in FIG. 18B, one or more of the magnets 30 may be embedded within the first member 1 and/or the second member 3. In some embodiments, the magnet(s) 30 may be embedded such that the magnet(s) 30 may not be visible on the lower surface 2 of the first member 1 and/or the upper surface 4 of the second member 2.

While two magnets 30 are illustrated in FIGS. 12, 18A, and 18B as having a rectangular shape and being located in substantially the center of the first member 1 and the second member 2, the removably attachable jewelry ornament 100 may include any number of magnets where each magnet may have any size and/or shape and/or may be located anywhere within the first member and/or the second member 2. For example, the first member 1 may include two magnets and the second member 3 may include one magnet where one magnet included in the first member 1 and the magnet included in the second member 3 may be located closer to the side edges of the first member 1 and the second member 3 in order to increase the coupling force at the portions of the first member 1 and the second member 3 that will detach first. The second member 3 may include further coupling material (e.g., metal) such that the second magnet of the first member 1 is magnetically coupled to the coupling material. Additionally or alternatively, the first member 1 may include a first magnet having a first shape and the second member 2 may include a second magnet having a second shape different from the first magnet.

In addition, while FIGS. 12, 18A, and 18B may illustrate that a magnet 30 is associated with both the first member 1 and the second member 3, the removably attachable jewelry ornament 100 may include a single magnet 30 in either the first member 1 or the second member 3 where the other member that does not include the magnet may include a coupling material (e.g., metal) such that the single magnet 30 is magnetically coupled to the coupling material.

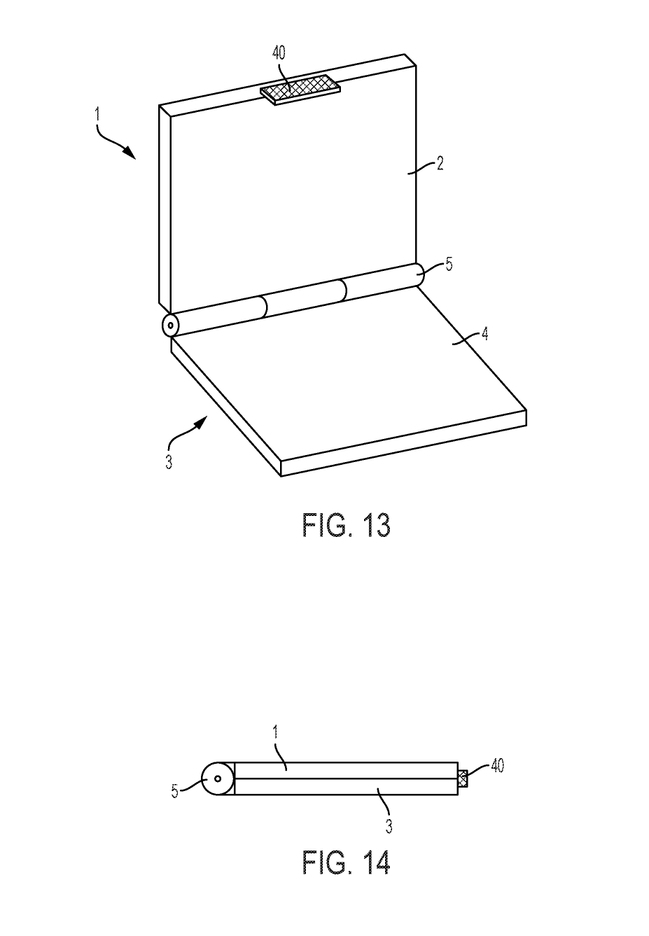

Referring to FIGS. 13 and 14, the removably attachable jewelry ornament 100 may include a clip 40 coupled to an outer surface of the first member 1. The clip 40 may be coupled with a surface of the second member 3 to couple the first member 1 with the second member 3 to allow the removably attachable jewelry ornament 100 to be coupled with a jewelry substrate. While not illustrated, in some embodiments, the second member 3 may include an additional receiving element or the second member 3 may be formed to include a recessed portion configured to accept an extension of the clip extending from an inner surface of the clip.

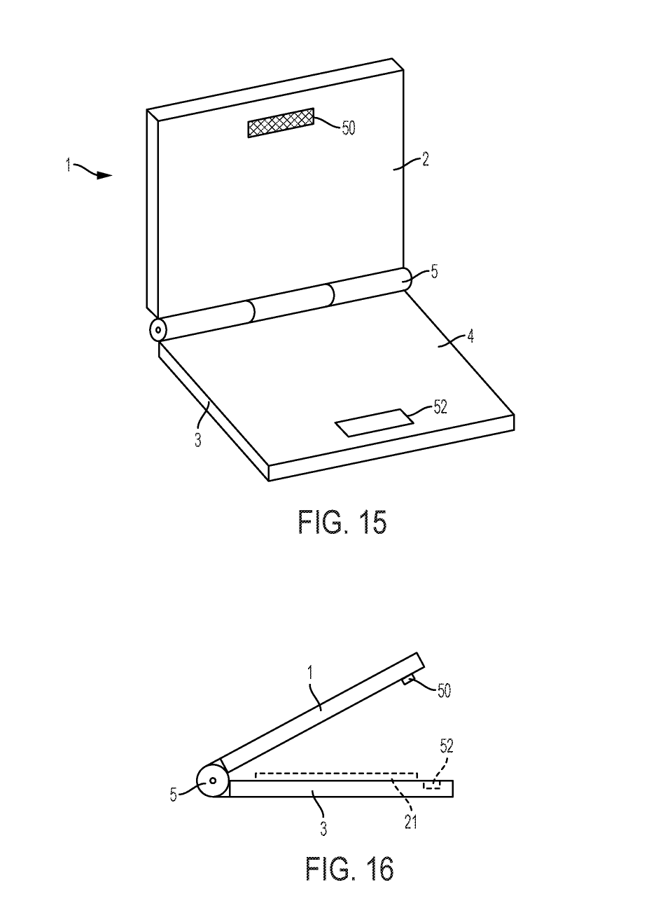

Referring to FIGS. 15 and 16, the removably attachable jewelry ornament 100 may include a post 50 coupled on the lower surface 2 of the first member 1 and an opening 52 formed in the upper surface 4 of the second member 3. The post 50 may be inserted into the opening 52 recessed within the second member 3 to allow the removably attachable jewelry ornament 100 to be coupled with a jewelry substrate (e.g., bracelet substrate 21). In some embodiments, the post 50 may be configured to include a ball at the end of the shaft such that a ball couples with the opening 52 in the second member 3 to aid in securing the first member 1 to the second member 3.

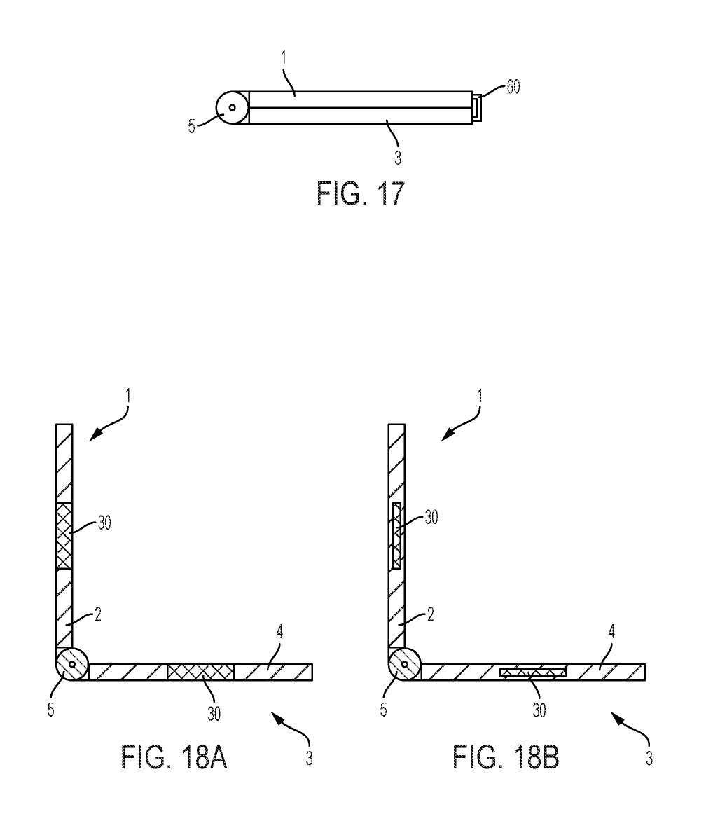

Referring to FIG. 17, the removably attachable jewelry ornament 100 may include a latch 60 coupled with an outer edge surface of the second member 3. The latch may be rotatable about an axis to allow the first member 1 to be coupled with the second member 3. While FIG. 17 illustrates the latch 60 being coupled with a side edge of the second member 3, the latch 60 may alternatively be coupled with a lower surface of the second member 3.

In some embodiments, the removably attachable jewelry ornament 100 may further include a radio-frequency identification (RFID) element. For example, the RFID element may be included in at least one of the first member 1, the second member 3, the articulation structure 5, and/or the jewelry substrate (e.g., the bracelet substrate 21). The RFID element may be any RFID device such as an RFID transmitter, an RFID microchip, an RFID tag, etc.

In some examples, the RFID element may be programmed for various implementations. For example, the RFID element may be programmed to allow a wearer access to restricted areas (e.g., “Only kids allowed beyond this point”), to gain access to a hotel room, to track location of the wearer, etc. In some examples, the RFID element of the removably attachable jewelry ornament 100 may be programmed before and/or after the removably attachable jewelry ornament 100 is acquired by a wearer.

The above description and associated figures teach the best mode of the invention. The following claims specify the scope of the invention. Note that some aspects of the best mode may not fall within the scope of the invention as specified by the claims. Those skilled in the art will appreciate that the features described above may be combined in various ways to form multiple variations of the invention, and that various modifications may be made to the configuration and methodology of the exemplary embodiments disclosed herein without departing from the scope of the present teachings. Those skilled in the art also will appreciate that various features disclosed with respect to one exemplary embodiment herein may be used in combination with other exemplary embodiments with appropriate modifications, even if such combinations are not explicitly disclosed herein. As a result, the invention is not limited to the specific embodiments described above, but only by the following claims and their equivalents.

What is claimed is:

1. A jewelry ornament removably attachable to a bracelet substrate, the jewelry ornament comprising:
a first member having an upper surface and a lower surface;
a second member having an upper surface and a lower surface; and
an articulation structure coupled with the first member and the second member, the articulation structure configured to allow the jewelry ornament to be removably coupled to the bracelet substrate;
wherein the lower surface of the first member includes a first portion configured to contact an upper surface of the bracelet substrate and a second portion configured to contact the upper surface of the second member,
wherein the upper surface of the second member includes a first portion configured to contact a lower surface of the bracelet substrate and a second portion configured to contact the lower surface of the first member,
wherein the entire lower surface of the first member is a flat surface arranged in a single plane, and
wherein the entire upper surface of the second member is a flat surface arranged in a single plane.

2. The jewelry ornament of claim 1, wherein the articulation structure is a hinge.

3. The jewelry ornament of claim 2, wherein the hinge is a floating hinge or a spring hinge.

4. The jewelry ornament of claim 1,
wherein the first member comprises:
a core formed of a rigid material; and
a covering formed of a flexible material in contact with at least a portion of the core of the first member,
wherein the second member comprises:
a core formed of a rigid material; and
a covering formed of a flexible material in contact with at least a portion of the core of the second member,
wherein the lower surface of the first member comprises the covering of the first member, and
wherein the upper surface of the second member comprises the covering of the second member.

5. The jewelry ornament of claim 4, wherein the articulation structure is coupled with the core of the first member and the core of the second member.

6. The jewelry ornament of claim 4, wherein the covering of the second member contacts a greater portion of the core of the second member than the covering of the first member contacts the core of the first member.

7. The jewelry ornament of claim 4, wherein the lower surface of the first member and the upper surface of the second member deform when in contact with the bracelet substrate.

8. The jewelry ornament of claim 1, further comprising:
a coupling element configured to removably couple the first member and the second member.

9. The jewelry ornament of claim 1, wherein the first member includes an article arranged on the upper surface of the first member.

10. The jewelry ornament of claim 9, wherein the article is at least one of an alphanumeric character, insignia, emblem, logo, icon, image, symbol, and an object.

11. The jewelry ornament of claim 9, wherein the article is a timepiece arranged on the upper surface of the first member.

12. The jewelry ornament of claim 1, wherein the jewelry ornament is fixedly attached to the bracelet substrate when the lower surface of the first member contacts the upper surface of the bracelet substrate and the upper surface of the second member contacts the lower surface of the bracelet substrate such that jewelry ornament is not readily movable with respect to the bracelet substrate.

13. The jewelry ornament of claim 1, wherein the bracelet substrate is a continuous band of flexible material.

14. The jewelry ornament of claim 1, wherein at least one of a length of the lower surface of the first member and a length of the upper surface of the second member is greater than a width of the bracelet substrate.

15. A bracelet comprising:
a bracelet substrate; and
a jewelry ornament removably coupled to the bracelet substrate, the jewelry ornament comprising:
a first member having an upper surface and a lower surface,
a second member having an upper surface and a lower surface, and
an articulation structure coupled with the first member and the second member, the articulation structure configured to allow the jewelry ornament to be removably coupled to the bracelet substrate,
wherein the lower surface of the first member includes a first portion configured to contact an upper surface of the bracelet substrate and a second portion configured to contact the upper surface of the second member,
wherein the upper surface of the second member includes a first portion configured to contact a lower surface of the bracelet substrate and a second portion configured to contact the lower surface of the first member,
wherein the entire lower surface of the first member is a flat surface arranged in a single plane,
wherein the entire upper surface of the second member is a flat surface arranged in a single plane, and
wherein the jewelry ornament is fixedly attached to the bracelet substrate when the lower surface of the first member contacts the upper surface of the bracelet substrate and the upper surface of the second member contacts the lower surface of the bracelet substrate such that jewelry ornament is not readily movable with respect to the bracelet substrate.

16. The bracelet of claim 15, wherein the bracelet substrate is a continuous band of a flexible material.

17. The bracelet of claim 16, wherein the flexible material is a woven material.

18. The bracelet of claim 15,
further comprising a radio-frequency identification (RFID) element,
wherein the RFID element is included in at least one of the first member of the jewelry ornament, the second member of the jewelry ornament, and the bracelet substrate.

19. An ornament removably attachable to a wearable substrate, the ornament comprising:
a first member having an upper surface and a lower surface;
a second member having an upper surface and a lower surface; and
an articulation structure coupled to the first member and the second member, the articulation structure configured to allow the ornament to be removably coupled to the wearable substrate;
wherein the lower surface of the first member includes a portion configured to contact a first surface of the wearable substrate,
wherein the upper surface of the second member includes a portion configured to contact a second surface of the wearable substrate,
wherein the entire lower surface of the first member is a flat surface arranged in a single plane, and
wherein the entire upper surface of the second member is a flat surface arranged in a single plane.

20. The ornament of claim 19, wherein the wearable substrate includes at least one of a circlet, a necklace, a bracelet, a ring, an anklet, a shoe lace, and clothing fabric.
